(19) United States
(12) Patent Application Publication
(10) Pub. No.: US 2015/0110966 A1
(43) Pub. Date: Apr. 23, 2015

(54) METHOD AND APPARATUS FOR PROVIDING A SUPPORT FOR THE TRANSFER OF AN UNIVOCAL DESIGN, AND SUPPORT THEREBY OBTAINED

(71) Applicant: Claudio SELVA, (US)

(72) Inventor: Claudio Selva, Biella Pavignano (IT)

(21) Appl. No.: 14/401,950

(22) PCT Filed: Sep. 26, 2012
(86) PCT No.: PCT/IT2012/000296

§ 371 Date: Nov. 18, 2014

(30) Foreign Application Priority Data
May 18, 2012 (IT) BI2012A000006
Jun. 15, 2012 (IT) BI2012A000007

(51) Int. Cl. B05C 19/04; B05C 19/00; B05C 19/06; B05D 1/36; B05D 3/12

(52) U.S. Cl. CPC B05C 19/04; B05D 1/36; B05D 3/12; B05C 19/06; B05C 19/008
USPC 427/470; 427/202; 427/598; 118/56; 427/201; 118/621; 118/623; 118/620

(57) ABSTRACT

A method for making a medium for transferring a univocal pattern, comprising the steps of preparing a transfer medium (1) provided with a transfer surface (2), preparing an amount of encapsulated microdrops (3) of color, applying a layer of adhesive material (4) or other material or technique adapted to stably withhold said micro droplets at least on said transfer surface, randomly distributing an amount of encapsulated microdrops of color at least on said surface. Apparatus for implementing the method and medium thereby obtained.

### TECHNICAL SECTOR OF THE INVENTION

The invention relates to a method and an apparatus for making a transfer medium, e.g. a ribbon or a film, coated with a layer of encapsulated microdrops of color anchored to the medium.

In different preferred applications, the invention relates to the complete or partial coating with microdrops of a continuous ribbon woundable on a spool or to a medium for graphic printing lines, or again to media in form of individual sheets.

The invention further relates to a method and apparatus for printing a univocal pattern by means of the medium thus obtained, e.g. by transferring the color from the transfer medium to a different medium, either on or off the graphic printing line, thus making the pattern directly on the transfer medium.

### PRIOR ART

The idea of micro encapsulating colors to be printed to create univocal, differentiated patterns is known in the sector of graphic printing in general.

This solution is described in International Application publications WO2008059552 and WO2010001203 by this inventor. In this an innovative printing system, different color micro capsules are mixed with a paint and randomly and indiscriminately distributed on a basic medium, and then crushed by pressure to obtain univocal printed signs, different from one another.

The systems described in WO2008059552 and WO2010001203, which are quoted herein as a whole, are a major innovation in the graphic printing sector, but the inventor has found that the industrial application of the system can be further improved.

A limitation of the prior art is indeed the relative rigidity of the procedure for making univocal patterns, in particular if it is necessary or preferable to apply the encapsulated microdrops of color off the printing line in various product sectors.

### OBJECT OF THE INVENTION

It is the object of the present invention to suggest a method and an apparatus for making a medium for transferring univocal patterns with one side coated with encapsulated microdrops of color, which, by means of dry crushing in contact with a printing medium, breaks the microdrops thus creating and printing a pattern which is different each time.

A further object of the invention is to suggest a method and an apparatus for making a univocal pattern during graphic printing.

### SUMMARY OF THE INVENTION

These objects are reached by a method and an apparatus according to at least one of the appended claims.

A first advantage is in that the method and the apparatus for making the transfer medium are extremely simple to apply and use, and can be implemented either on or off the graphic printing process line.

A second advantage is in that the colored univocal pattern thus obtained may be used to customize each single print and be adopted as anti-counterfeiting system.

### LIST OF DRAWINGS

These and further advantages will be better understood by a person skilled in the art from the description that follows and the accompanying drawings, provided by way of non-limitative example, in which:

FIG. 1 diagrammatically shows the sequence of steps of a method for making a transfer medium according to the invention;

FIG. 2 diagrammatically shows an apparatus according to the invention for transferring a univocal pattern onto a printing medium;

FIG. 3 diagrammatically shows some possible techniques for applying encapsulated microdrops of color onto a transfer medium;

FIG. 4 shows a possible diagram of an apparatus for making a transfer medium according to the invention;

FIG. 5 shows a possible diagram of an apparatus for making a transfer medium according to the invention on-line with a univocal pattern printing device;

FIG. 6 shows a diagram of a preferred embodiment of an apparatus according to the invention.

### DETAILED DESCRIPTION

The figures show a method for making a univocal pattern during graphic printing by crushing encapsulated microdrops of color.

The method includes making a transfer medium 1 of the univocal pattern, e.g. a thin polyester film, with one side completely coated with a compact layer of encapsulated microdrops 3 of color, anchored to the paper medium by means of an adhesive 4, preferably a transparent high-adhesion, fast-drying varnish, or by means of glues, resins, inks or any other system adapted to make the microdrops adhere to the material of the medium.

Preferably, in an embodiment of the method, reflecting glitter or phosphorite or other micro particles which allow better visibility of the printed pattern but which cannot be replicated by photocopying or scanning, may be mixed to the encapsulated microdrops.

This solution consequently allows to preliminarily check authenticity of the patterns as anti-counterfeiting function by checking whether the added micro particles are present in the pattern or not.

Advantageously, if the transfer medium is in the form of continuous ribbon, the medium 1 with the encapsulated microdrops of color may then be wound on a spool 10 (FIG. 4) to be inserted in a complete apparatus for making the transfer medium and printing on a printing base medium 24 (FIG. 2).

By way of example, such an apparatus comprises a first unwinder/winder W1 which moves the transfer medium 1 and a second unwinder/winder W2 which moves the printing medium 24.

A printing assembly 20, comprising for example a roll 20 with plate 26 and counter roll 27, is provided between the two unwinders.

In operation, the medium 1 with the encapsulated microdrops of color is mated and inserted together with the medium to be printed 24 between the plate roll and the counter roll. The microdrops of color are broken by the pressure exerted by the plate roll and by the counter roll, thus creating the printing of a differentiated, univocal pattern on the medium 24.

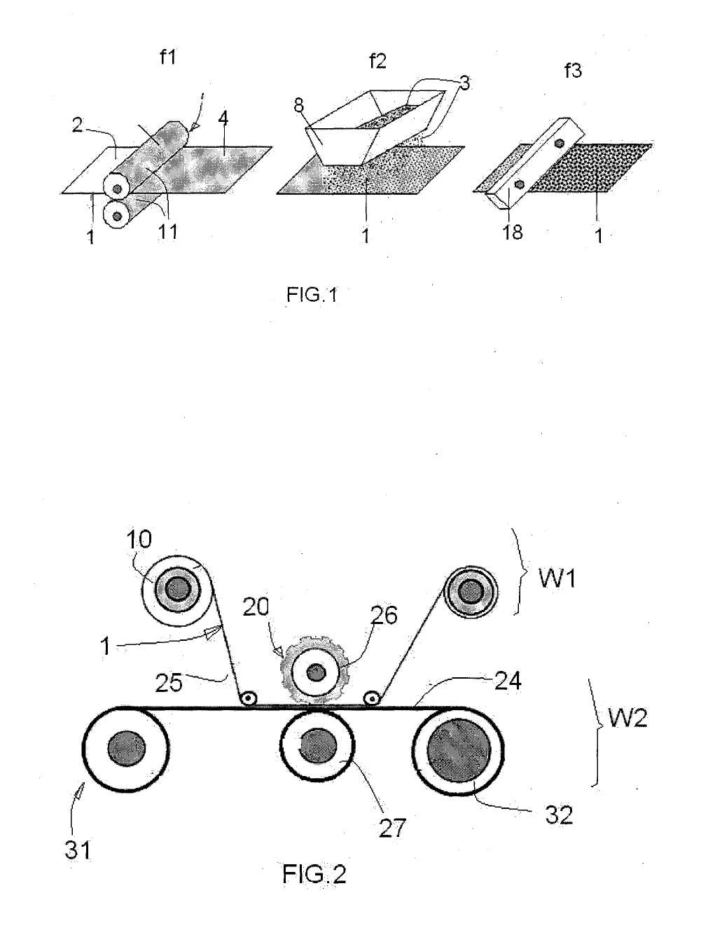

With reference to FIG. 1, the transfer medium is obtained by means of a series of opposite rolls, thus providing a compact, uniform layer 4 of adhesive, preferably a high-viscosity, quick-drying varnish which is reactive to UV lamps or IR infrared lamp, air ovens or any other system for drying the color and making it strong and constant over time, on one side of the medium 1 only (step f1).

The glued medium 1 advances and passes under a container 8 filled with encapsulated microdrops 3 of color, e.g. of the size of 30-60 micron, which by means of a sieve (step f2) distributes them indiscriminately on the entire surface underneath, previously treated with high-adhesion varnish.

Finally, the medium carrying the varnish and the encapsulated microdrops of color passes under a UV lamp or an IR infrared lamp, in air ovens or any system for drying the color and making it strong and constant over time (step f3), which dries it immediately and anchors the encapsulated microdrops of color onto the surface of the same.

Advantageously, in the case of continuous ribbon-like medium 1, the medium thus obtained is packed and wound on a spool 10 (FIG. 2) to then be used in a later printing process, e.g. by means of dry transferring of the microdrops, which when crushed during graphic printing, impress a univocal, multicolor drawing onto a printing medium 24 coupled thereto.

In a preferred embodiment of the method, the medium carrying the microdrops, before being wound on the spool 10, may be subjected to crushing and subsequent application of a layer of transparent varnish.

Advantageously, a transfer medium carrying the univocal patterns to be transferred which may be used in particular for heat transfer techniques, is obtained with this solution.

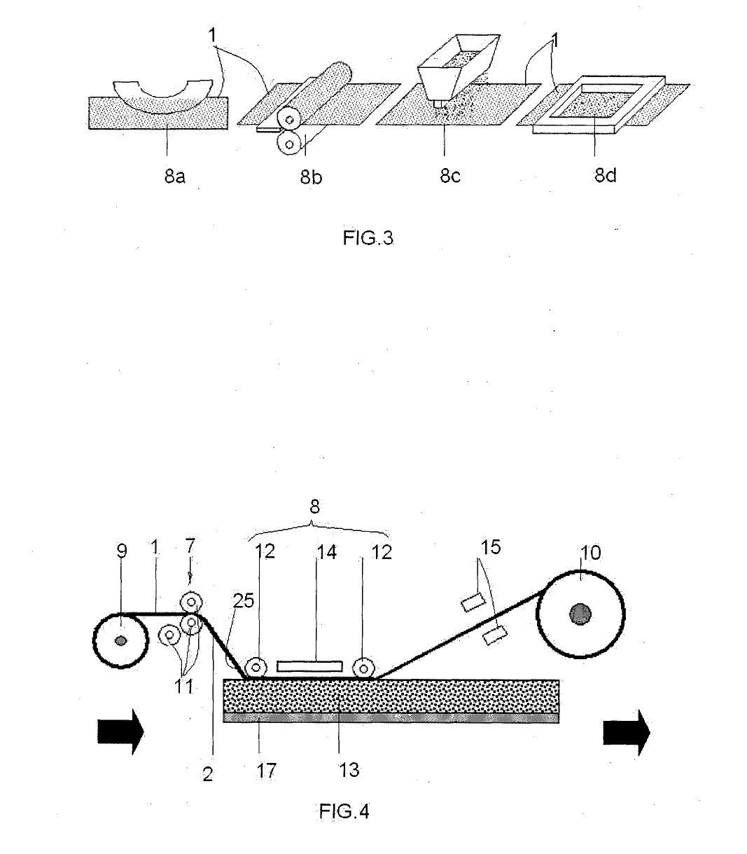

FIG. 3 diagrammatically shows various procedures (provided by way of non-limitative examples) for applying the encapsulated microdrops 3 of color onto the transfer medium. In particular, the figures show a technique by means of immersion in a chemical reaction container (8a), by roller printing (8b), indiscriminate or regulated dispersion (8c), silk-screen printing and spreading (8d) or vertical immersion in a tank.

We will now briefly illustrate the printing apparatus in FIG. 2, which inserted on normal graphic printing lines allows to provide a differentiated, univocal pattern on a printing support 24.

The spool 10 with the encapsulated microdrops of color is inserted in a winder-unwinder W1 with the side of the ribbon 25 with the encapsulated microdrops of color facing the inside of the spool.

A winder-unwinder w2 underneath conveys a printing medium 24, e.g. paper, onto which the univocal pattern will be printed, by dry transfer in this illustrated case, on the line.

Both the medium 1 with the layer of encapsulated microdrops of color and the paper to be printed pass between a roll 26 with plate 20 and a counter roll 27 in contact with the coupled media 1, 24 which break the microdrops of color by pressure.

With this solution, the microdrops, by breaking in direct contact with the paper underneath, create each time univocal patterns which is are differentiated for the color and the random positioning of the microdrops.

Advantageously, the method and apparatus thereof described above is simple to apply and manage, and may be inserted either on or off a graphic printing process line in which the univocal color pattern obtained customizes each single print allowing use as anti-counterfeiting system on any printing line in general, and on various printing media, such as paper, ceramic, glass, metal, plastic which require the printing of a univocal pattern.

A preferred embodiment for making a transfer medium in form of continuous ribbon is shown now in FIG. 4.

A ribbon 1, e.g. a transparent polyester ribbon, departs from a unwinding spool 9, which passes into a gluing assembly 7 provided with rolls 11 which spread glue on the inner side 25 of the ribbon.

The ribbon is then made to transit on a layer of encapsulated microdrops 3 of color distributed in a container 13.

The inner part 25 of the transparent polyester ribbon spread with glue, in contact with the microdrops make them adhere and create a compact, uniform surface coat. Finally, the ribbon is wound on a spool 10.

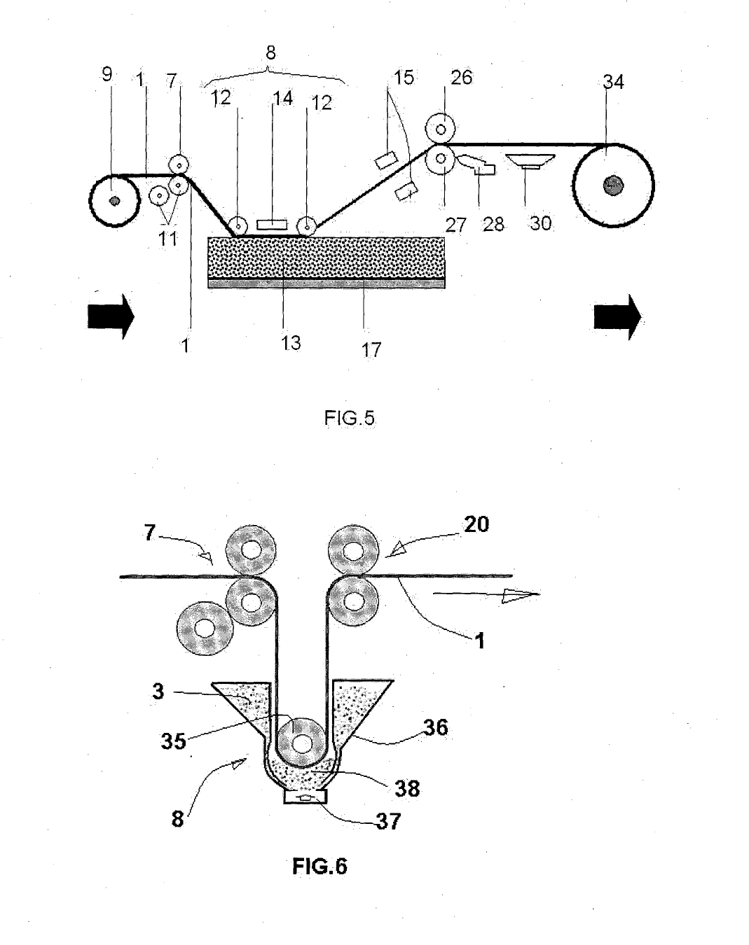

With reference to FIG. 5, the same procedure may be essentially adopted for printing a univocal sign either on or off a normal line during graphic printing.

In such a case, by means of the rolls 11, which may carry engraving of any shape or pattern, a portion of adhesive, e.g. high-adhesion varnish, having any pattern, is applied onto the medium 1.

The medium 1 carrying the adhesive portions with the pattern passes on the microdrops 3, which are glued onto the adhesive portion and repeat the pattern thereon.

Afterwards, by passing between the two rolls 26, 27, the microdrops of color pressed by the rolls are broken and create a univocal drawing on the printed medium which may be wound on a spool 34.

In greater detail, in the described embodiment, a ribbon 1 departs from the unwinder spool 9 and then passes into the roll assembly, named glue spreader 11, which either entirely or partially spread glue on the inner side 25 of the ribbon.

In the following segment, the ribbon is conveyed downward and held taut by two conveyor rolls 12 which make the microdrops of color adhere totally to the inner part of the transparent polyester ribbon spread with glue.

Preferably, an electrostatic or electromagnetic induction strain-relieving blow pressure or friction plate 14 may be used for a more complete, total coverage of the adhesive surface of the medium 1 with the encapsulated microdrops of color.

Advantageously, if an electrostatic induction plate is used, it will be possible to attract colored, organic micro particles, e.g. salt or sugar, preferably of size from 100 to 600 micron, by way of non-limitative example, in addition to microdrops.

Furthermore, if an electromagnetic induction plate is used it will be possible to attract variably colored ferrous micro particles, preferably of size from 100 to 600 micron, by way of non-limitative example, in addition to microdrops.

Moreover, the upper part of the ribbon 1 may pass in an electrostatic load neutralizer, an air or suction barrier 15 which lets possible microdrops of color in excess or residual microdrops of color either fall into the tank 13 underneath or aspirates them.

Finally, the ribbon 1 is then wound on a spool 10, e.g. with a winder.

Preferably, the bottom of the containment tank 13 of the microdrops is provided with an upward movement device 17 synchronized with the advancement of the ribbon 1 so as to keep the contact level constant on the surface of the encapsulated microdrops with the adhesive base of the ribbon.

Preferably, in case of adhesion of the microdrops to the spool, by means of an electrostatic or electromagnetic system 14, the feeding tank 13 may be positioned a given distance from the ribbon.

As seen, the diagram in FIG. 4 may also be adopted, with changes or appropriate accessories, to directly print a univocal sign on a transfer medium 1 on the printing line.

In this case, the medium 1, e.g. paper, from the unwinding spool 9 passes through the gluing assembly with the rolls 11 which print from the bottom ad adhesive portion of any pattern on the back underneath the medium.

The medium is then conveyed downwards and held taut by the rolls 12 and by the possible plate 13, so that the microdrops, in contact with the pattern printed with high-adhesion varnish, adhere to the glue and cover it completely, thus repeating the pattern, before passing in the electrostatic load neutralizer and between the two opposite rolls 26, 27 (smooth continuous rolls in such a case), which crush the microdrops of color glued onto the sign, thus forming a univocal pattern on the medium 1.

A scraping doctor 28 cleans possible crushed microdrop residues. Finally, the resulting univocal drawing passes under a UV lamp 30 for drying and final polymerization.

FIG. 6 diagrammatically shows a further embodiment of an apparatus for making media, and for directly printing univocal patterns according to the invention.

In such a case, the apparatus comprises an assembly 7 of the type described above which applies glue, either partially in the case of direct painting of the univocal sign or totally in the case of making ribbon for transferring onto a medium 1 which is advancing horizontally. The medium 1 is diverted vertically by means of a vertical idle roll 35 to be immersed and then emerge from a hopper container 36 containing the microdrops 3, which are made to adhere to the glue by contact in a lower collection cradle 38, possibly with the assistance of a blow from the bottom 37.

At the outlet of the container 36, the medium may pass through a crushing assembly of the microdrops 20 of the type described above or wound back on a spool in case of ribbon-shaped medium.

According to the invention, the transfer medium 24 of the univocal pattern is additionally provided with a portion of adhesive layer 4, with a further outer layer formed by transparent varnish, protective film, or resin arranged to protect or transfer univocal drawings generated by the crushed microdrops onto the medium.

The outer film may be of the type adapted for heat transfer of the pattern.

With this solution, transferring the univocal pattern from the medium 24 to another medium of any type may be obtained by means of techniques known in themselves, e.g. by heat transfer of the outer film carrying the pattern.

The present invention is described herein according to preferred embodiments but equivalent variants may be devised without because of this departing from the provided scope of protection.

It is further described a transfer medium of a univocal pattern, comprising a base 1 provided with at least one portion of an adhesive layer 4 on which an amount of compression-fragile encapsulated microdrops of color 3 is stably withheld is provided.

The base may be a continuous ribbon wound on a spool or an individual sheet.

It is also described a medium for transferring a univocal pattern, comprising a base 24 provided with at least one portion of an adhesive layer 4 on which at least one univocal pattern originated by crushing an amount of compression-fragile encapsulated microdrops of color 3 is applied, the medium comprising a further outer layer of transparent varnish or protective film, e.g. of the heat transfer type, arranged to either protect or transfer the univocal patterns generated on the medium by the crushed microdrops.

The base may be a continuous ribbon wound on a spool or an individual sheet.

Again it is described a printing method of a univocal pattern starting from a transfer medium above described, comprising a step of transferring a univocal pattern onto the transfer medium by means of hot or dry pressure, pad printing or other techniques adapted to determine the transfer of the pattern by means of crushing compression of said microdrops.

The step of transferring may be implemented on a printing line and following a method of making a transfer medium as described above.

In the printing method the formulation of the colors encapsulated the microdrops may be chosen according to the printing medium on which they must be transferred and crushed, and possibly mixed with magnetic responding metallic pigments adapted for detecting the printed datum.

Moreover the colors encapsulated in the microdrops may be mixed with reflecting glitter, phosphorite or micro particles to increase visibility of printed sign.

The printing method may comprise a preliminary step of selecting a printing medium 24 different from the transfer medium and a step of approaching the printing medium to a side 25 of the transfer medium carrying the encapsulated microdrops.

It is further described a printing apparatus of a univocal pattern starting from a transfer medium referred above, comprising means 20 for transferring a univocal pattern by means of hot or dry pressure, pad printing or other techniques adapted to determine the transfer the pattern by means of crushing compression of said microdrops.

The transfer medium may be in the form of a continuous ribbon and said transfer means 20 comprise a pair of opposite plate rolls and counter roll 26, 27 which crush at least one portion of the color microdrops glued onto the transfer medium thus forming a univocal pattern on the medium.

The apparatus may comprise a scraping doctor (28) arranged downstream of said transfer means to clean possible residues of crushed microdrops.

The apparatus may also comprise a UV lamp (30) arranged downstream of said transfer means for drying and polymerizing the color.

It may also have means 31 for approaching a printing medium 24 on one side 25 of the transfer medium carrying the microdrops 3 operating downstream of said transfer means 20.

In the apparatus said printing medium may be a continuous ribbon and in may comprises means 32 for winding the printed ribbon 24 onto a spool.

The printing medium may also consists of a sequence of individual sheets.

1. A method for making a medium for transferring a univocal pattern, comprising the steps of:
preparing a transfer medium (1) provided with a transfer surface (2),
preparing an amount of compression-fragile encapsulated microdrops (3) of color,
applying a layer of adhesive material (4) or other material or technique adapted to stably withhold said micro droplets at least on said transfer surface,
randomly distributing an amount of encapsulated microdrops of color at least on said surface.

2. A method according to claim 1, wherein said step of distributing is implemented by means of a technique chosen from the group including aspersion, chemical reaction immersion, silk-screen printing, spreading, coupling, blowing, electrostaticity, electromagnetism or other technique adapted to the purpose of anchoring the microdrops of color to the medium.

3. A method according to claim 1, wherein said microdrops are mixed with variably colored organic micro particles e.g. salt or sugar, and/or variably colored ferrous micro particles, e.g. ferrite powder or sand.

4. A method according to claim 1, wherein said medium is made of a material chosen from the group including paper, polyester, plastic or other material adapted for printing in general.

5. A method according to claim 1, wherein the formulation of said adhesive material is chosen according to the material of the transfer medium, e.g. paper, plastic, ceramic, metal or material of other nature, for the purpose of promoting the anchoring of the microdrops to the medium and to place a univocal sign thereon.

6. A method according to claim 1, wherein said medium is a medium in the form of continuous ribbon.

7. A method according to claim 1, wherein said medium is a medium in the form of individual sheets.

8. An apparatus for making a transfer medium of a univocal pattern, comprising:
feeding means of a transfer medium (1) provided with a transfer surface (2),
feeding means of an amount of compression-fragile encapsulated microdrops of color,
means (7) for applying a layer of adhesive material adapted to stably withhold said microdrops at least on said transfer surface (2),
means (8) for randomly distributing an amount of encapsulated microdrops of color at least on said transfer surface (2), wherein said medium is a medium in the form of continuous ribbon, e.g. made of polyester, and said feeding means (5) of the medium comprise a feeding device from a spool (9), the apparatus further comprising a spool collection device (10) of the transfer medium with said applied microdrops, wherein the apparatus further comprises means for crushing said microdrops applied to the medium (1) and means for applying a further layer of transparent varnish or protective film, e.g. of the heat transfer type, arranged to either protect or transfer the univocal patterns generated on the medium by the crushed microdrops are provided upstream of said spool (10).

9. An apparatus according to claim 8, wherein said distributing means (8) are chosen from the group including means for distributing by aspersion, chemical reaction immersion, silk-screen printing, spreading, coupling, blowing, electrostaticity, vertical immersion or other technique adapted for the purpose of anchoring the microdrops of color to the medium.

10-12. (canceled)

13. An apparatus according to claim 8, wherein said means (7) for applying a layer of adhesive comprising a set of rolls (11) which spread glue, or paint, resin, ink on said ribbon or other system adapted to make the microdrops adhere to the material.

14. An apparatus according to claim 8, wherein said means (8) for distributing said microdrops comprise conveyor rolls (12) of the ribbon which press the side of the ribbon with the glue onto a layer of encapsulated microdrops of color distributed in a container (13).

15. An apparatus according to claim 14, wherein said means (8) for distributing said microdrops comprise an electrostatic or electromagnetic induction stretching blow sure or friction plate (14) arranged over the ribbon and the (13).

16. An apparatus according to claim 8, comprising an electrostatic charge neutralizer or an air or suction barrier (15) arranged downstream of said distributing means (8) and which makes possible microdrops of color in excess fall into a tank (13) underneath.

17. An apparatus according to claim 16, wherein said tank (13) is provided with an upward feeding device (17) synchronized with the advancement of the transfer medium to keep the surface contact level of the encapsulated microdrops always constant with the glued side of the medium.

18. (canceled)

19. An apparatus according to claim 8, comprising a quick drying device (18) with UV lamps or IR infrared lamp or any for drying the color and making strong and constant over time arranged downstream of said means (8) for distributing the microdrops to dry and anchor the encapsulated microdrops of color onto the surface of the medium.

20. An apparatus according to claim 8, wherein said means (7) for applying a layer of adhesive on the medium are arranged to apply one of more individual patterns on a medium, e.g. in the form of quadrangular portions in the case of univocal signs.

21-39. (canceled)
